(19) United States
(12) Patent Application Publication
(10) Pub. No.: US 2009/0101077 A1
(43) Pub. Date: Apr. 23, 2009

(54) My pet shower

(76) Inventors: Basma Shaham, Monroe, CT (US); Emily Shaham, Monroe, CT (US)

Correspondence Address: JAMES RAY & ASSOCIATES, 2640 PITCAIRN ROAD, MONROEVILLE, PA, 15146, US

(21) Appl. No.: 12/288,195

(22) Filed: Oct. 17, 2008

Related U.S. Application Data
(60) Provisional application No. 60/980,467, filed on Oct. 17, 2007.

(51) Int. Cl. A01K 13/00; A01K 29/00

(52) U.S. Cl. 119/673; 119/677

(57) ABSTRACT

A four-legged animal washing apparatus includes a housing defining a washing chamber that is shaped to contour the animal and having a quartet of generally hollow abutments disposed in a predetermined pattern on and extending outwardly from a bottom wall of the washing chamber. A first opening is formed in a top portion of the housing and a cover is provided for selectively opening and closing the first opening. A second opening is formed in the front portion of the housing to receive a neck of such animal. Spraying nozzles are directed into the washing chamber and are connected to a liquid pump operable by a controller. At least one drain is provided for draining liquid from the washing chamber. An optional air heating assembly supplies heated air into the washing chamber through air ports. Sensor is employed for detecting presence of the liquid in the washing chamber.

### CROSS-REFERENCE TO RELATED APPLICATIONS

This application is related to and claims priority from Provisional Patent Application Ser. No. 60/980,467 filed on Oct. 17, 2007.

### FIELD OF THE INVENTION

The present invention relates, in general, to animal baths and, more particularly, this invention relates to four-legged pet washing apparatus containing the pet therewithin so that the pet can be sprayed with water under pressure and dried with air.

### BACKGROUND OF THE INVENTION

As is generally well known, bathing a dog or a cat can be a challenging activity if the pet owner attempts to do it in the confines of a home. Most animals don't like getting a bath and do not cooperate. This can be a frustrating process and may result in the pet owner getting drenched and left with a mess to clean up afterwards. A trip to a pet grooming shop also has its disadvantages, as the pet owner would have to find the time in his or her busy schedule to make and keep an appointment. Also, a trip to the pet grooming shop can be expensive, considering that the animal will be dirty again soon.

Prior to the conception and development of the present invention, efforts have been made to alleviate difficulties of bathing the dog or the cat. U.S. Pat. No. 6,688,257 issued to Lee, U.S. Pat. No. 5,632,231 issued to Moore, U.S. Pat. No. 7,107,937 issued to Anderson, U.S. Pat. No. 7,080,608 issued to Arndt et al. and U.S. Pat. No. 5,193,487 issued to Vogel disclose various apparatuses and devices suitable for bathing four-legged pets, such as cats and dogs.

However, there is a need for an improved pet washing apparatus containing the pet therewithin so that the pet can be sprayed with water under pressure and dried with air.

### SUMMARY OF THE INVENTION

The invention provides a four-legged animal washing apparatus. The apparatus includes a housing. The housing defines a washing chamber having each of a predetermined size and a predetermined shape to receive a body of an animal and further defining each of a bottom wall, a front wall, a back wall and a pair of side walls. There is a quartet of generally hollow abutments disposed in a predetermined pattern on and extending outwardly from the bottom wall. Each of the plurality of generally hollow abutments has a generally closed bottom end and an open top end disposed in open communication with the washing chamber. Each generally hollow abutment defines a cavity having each of a predetermined size and a predetermined shape to receive a respective foot of such animal having such body thereof received within the washing chamber. A first opening is formed in a top portion of the housing. A second opening is formed in a front portion of the housing in operative communication with the first opening. The second opening has a predetermined size to receive a neck of such animal. A cover is pivotally attached to one of the back wall and one of the pair of side walls and manually movable between a closed position and an open position. The cover disposed in the closed position covers the first opening and forms a top wall of the chamber, wherein a front end of the cover disposed in the closed position is shaped to fit about such neck of such animal. There is means for delivering a washing liquid into the washing chamber and onto such animal. There is also means for controlling operation of the liquid delivering means. Means is also operatively mounted within the apparatus for draining the washing liquid from the washing chamber.

The invention also provides a four-legged animal washing apparatus that includes a housing defining a washing chamber. The washing chamber has each of a predetermined size and a predetermined shape to receive a body of an animal and further defining each of a bottom wall, a front wall, a back wall and a pair of side walls. There is a quartet of generally hollow abutments disposed in a predetermined pattern on and extending outwardly from the bottom wall. Each of the plurality of generally hollow abutments has a generally closed bottom end and an open top end disposed in open communication with the washing chamber. Each generally hollow abutment defines a cavity having each of a predetermined size and a predetermined shape to receive a respective foot of such animal having such body thereof received within the washing chamber. A first opening is formed in a top portion of the housing. A second opening is formed in a front portion of the housing in operative communication with the first opening. The second opening has a predetermined size to receive a neck of such animal. A cover is pivotally attached to one of the back wall and one of the pair of side walls and manually movable between a closed position and an open position. The cover disposed in the closed position covers the first opening and forms a top wall of the chamber, wherein a front end of the cover disposed in the closed position is shaped to fit about such neck of such animal. There is means for sealing abutting engagement of the cover with respective terminal edges of the housing. A predetermined plurality of liquid spraying jet nozzles is provided. A portion of the predetermined plurality of liquid spraying jet nozzles is mounted in each of the front wall, back wall, bottom wall, side walls and cover. A pump is provided and is energizeable to circulate liquid under pressure. A manifold assembly has an inlet thereof operatively coupled to a pump outlet and a plurality of outlets. Each of the plurality of outlets operatively coupled to a respective liquid spraying jet nozzle. A suction port is operatively mounted in a predetermined wall of the washing chamber. A conduit is provided and has one end thereof operatively coupled to the suction port. The opposed end of the conduit is operatively coupled to a pump inlet. There is a liquid level sensor mounted a predetermined distance from the bottom wall in one of the side walls, front wall and back wall. The liquid level sensor provides a liquid level signal upon sensing presence of the liquid in the washing chamber. A control assembly is operatively coupled to each of the sensor and the pump and operable at least in response to the liquid level signal to energize the pump. A drain assembly is operatively mounted in the bottom wall of the washing chamber. There is a quartet of openings with each opening formed through a wall of a respective generally hollow abutment. A quartet of plugs is also provided with each plug selectively closing and opening a respective opening. There is means provided for supplying forced heated air into the washing chamber. At least one sensor is mounted in one of the side walls, front wall, bottom wall, back wall and cover for measuring distance from an interior surface of the washing chamber to such animal by transmitting ultrasound signals beamed onto such animal and receiving signals reflected therefrom.

### OBJECTS OF THE INVENTION

It is, therefore, one of the primary objects of the present invention to provide a pet washing apparatus that defines a chamber capable of containing the pet therewithin.

Another object of the present invention is to provide a pet washing apparatus that is shaped to define a shape of the pet contained therewithin.

Yet another object of the present invention is to provide a pet washing apparatus that includes spraying jet nozzles and a water pump capable of circulating water under pressure through the spraying jet nozzles.

A further object of the present invention is to provide a pet washing apparatus that allows dirty water to be drained therefrom.

Yet a further object of the present invention is to provide pet washing apparatus that is capable of drying the pet with warm air.

An additional object of the present invention is to provide pet washing apparatus that is easy to use.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 illustrates an environmental view of a four-legged pet washing apparatus of the present invention;

FIG. 2 is a perspective view of the apparatus of FIG. 1, particularly showing the cover in an open position for inserting body of the pet into or removing it from the washing chamber;

FIG. 3 is a side elevation view of the apparatus of FIG. 1;

FIG. 4 is a cross-sectional view along lines IV-IV of FIG. 3, particularly illustrating a drain arrangement;

FIG. 5 is a cross-sectional view along lines V-V of FIG. 3, particularly illustrating a spraying jet nozzle arrangement;

FIG. 6 illustrates a schematic diagram of means for delivering liquid into the washing chamber of the apparatus of FIG. 1;

FIG. 7 illustrates a schematic diagram of a control arrangement of the apparatus of FIG. 1; and

FIG. 8 illustrates a schematic diagram of means for delivering heated air into the washing chamber of the apparatus of FIG. 1.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

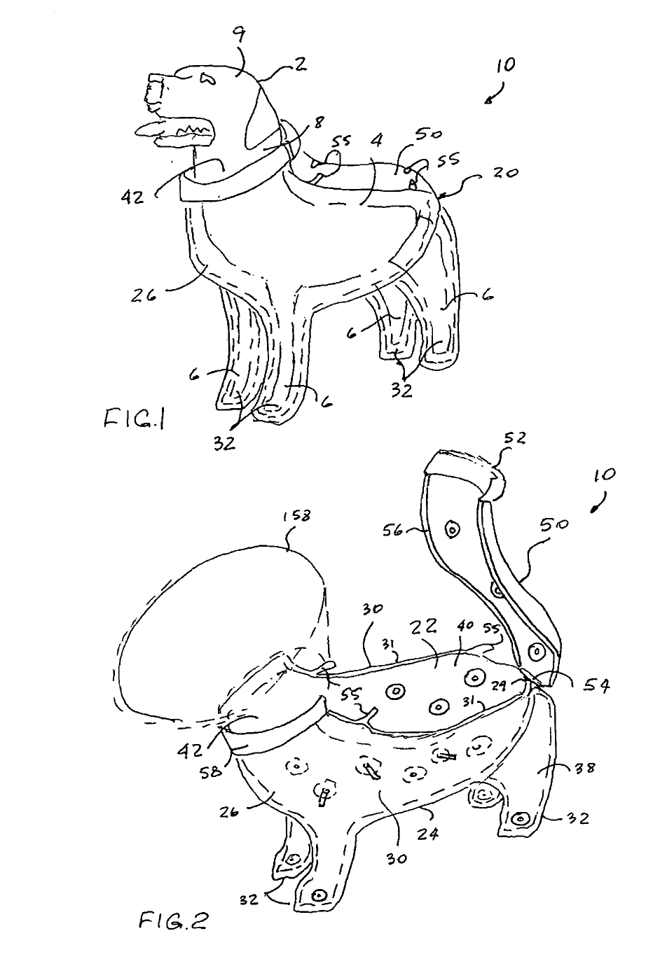

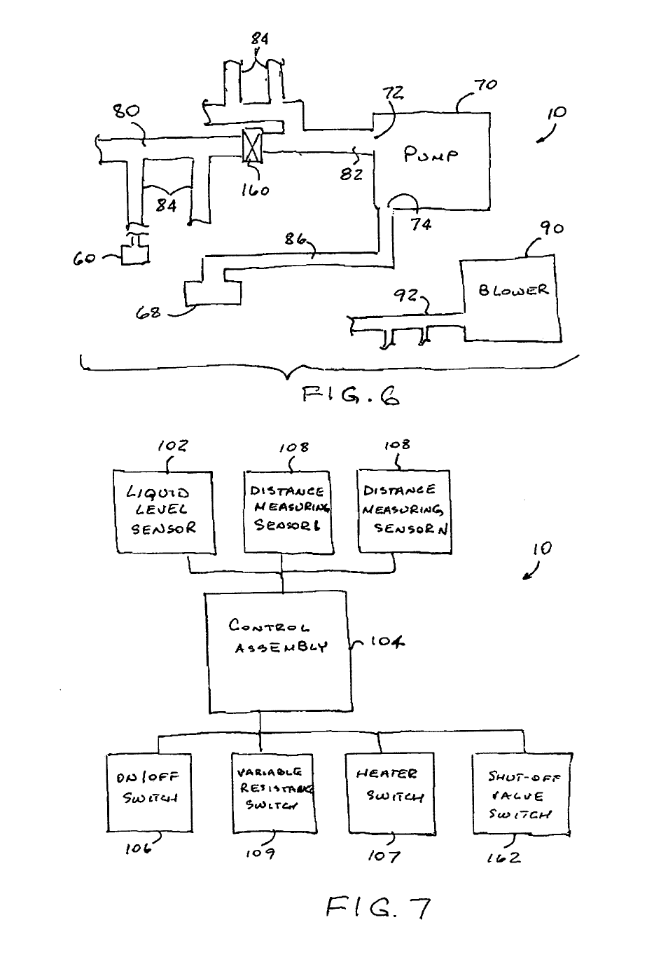

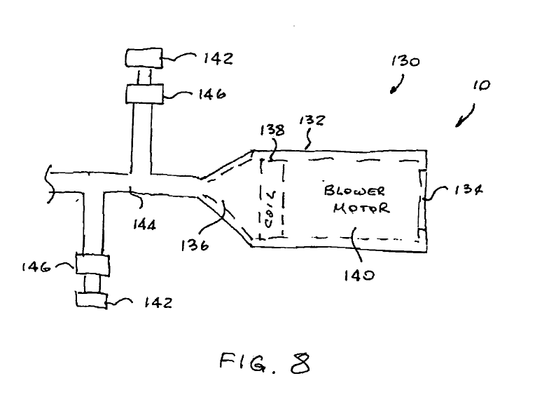

The best mode for carrying out the invention is presented in terms of its presently preferred embodiment, herein depicted within FIGS. 1 through 8. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one particular configuration shall be shown and described for purposes of clarity and disclosure and not by way of limitation of scope.

Reference is made, to FIGS. 1-8, wherein there is shown a four-legged animal washing apparatus, generally designated as 10. Now in a particular reference to FIGS. 1-3, the apparatus 10 includes a housing 20 defining a washing chamber 22 having each of a predetermined size and a predetermined shape to receive a body 4 of such four-legged animal 2. Preferably, the predetermined shape of the housing 20 contours the shape of the animal body 4. The housing 20 and the washing chamber 22 further define each of a bottom wall 24, a front wall 26, a back wall 28 and a pair of side walls 30. There is also a quartet of generally hollow abutments 32 disposed in a predetermined pattern on and extending outwardly from the bottom wall 24. Each of the quartet of generally hollow abutments 32 has a generally closed bottom end 34 and an open top end 36 disposed in open communication with the washing chamber 22. Each generally hollow abutment 32 defines a cavity 38 having each of a predetermined size and a predetermined shape to receive a respective foot 6 of such animal 2 having such body 4 thereof received within the washing chamber 22. It is not necessary for the hollow abutments 32 to be of the same size and/or shape and it is further presently preferred to shape and size the front hollow abutments 32 differently from the rear hollow abutments 32 to naturally accommodate different front and rear legs of the animal 2. Furthermore, it is contemplated by the present invention that the cavities 38 may be sized larger than the feet 6 of the animal 2 so that the animal 2 of various sizes can be positioned within the washing chamber 22.

The housing 20 is preferably manufactured from a clear (transparent or translucent) plastic material enabling the user of the apparatus 10 to observe the washing process of the animal 2 within the washing chamber 22 and enhance manual control of such washing process.

A first opening 40 is formed within the housing 20 by a combination of terminal edge 31 of each side wall 30 and a terminal edge 29 of the back wall 28. The first opening 40 is sized to allow passage of the animal body 4 therethrough.

A second opening 42 is also provided and is formed in the front wall 26 and the pair of side walls 30 in operative communication with the first opening 40. The second opening 42 has each of a predetermined size and shape to receive a neck 8 of such animal 2. In operation the body 4 of the animal 2 is inserted into the washing chamber 22 through the first opening 40 with the head 9 of the animal 2 protruding outwardly from the housing 20 by way of the second aperture 42.

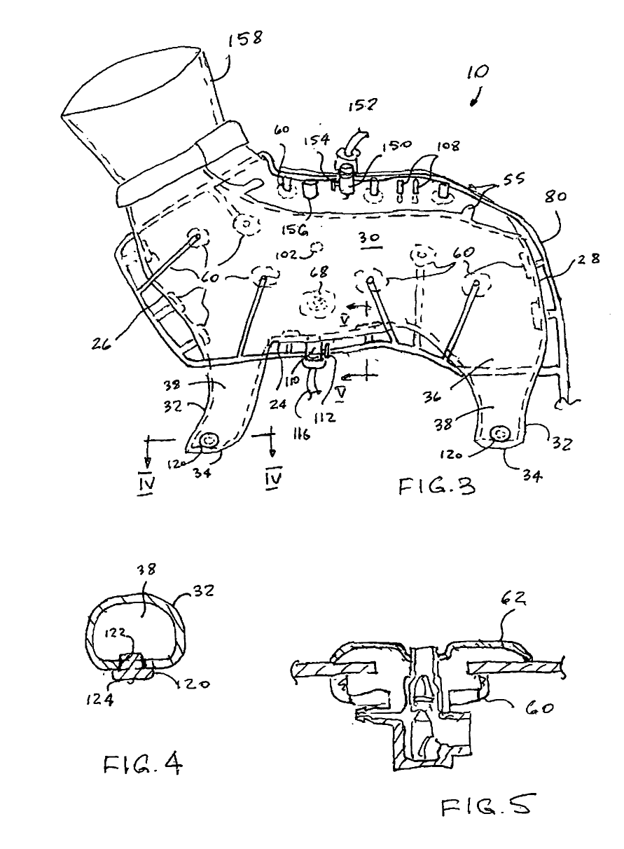

A cover 50 is pivotally attached to one of the back wall 28 and one of the pair of side walls 30. The cover 50 and is manually movable between a closed position of FIGS. 1 and 3 and an open position of FIG. 2. When the cover 50 is disposed in the closed position, it covers the first opening 40 and forms a top wall of the washing chamber 22. Also, a front end 52 of the cover 50 being disposed in the closed position is shaped to fit about such neck 8 of such animal 2 and completes the edge of the second opening 42. The front edge 52 may be disposed upwardly at an angle relative to the remaining portion of the cover 50 to counter the shape of the animal 2. A simple hinge 54 is provided to enable such pivotal attachment of the cover 50. The cover 50 is also preferably manufactured from such clear plastic material. Advantageously, when both the housing 20 and the cover 50 are manufactured from plastic material, they can be formed integrally therewith, for example by a well known molding process, with the hinge 54 also integrally formed into the apparatus 10.

There is also means for sealing abutting engagement of the cover 50 with respective edges of the housing 20, specifically the terminal edges 31 of the side walls 30 and the terminal edge 29 of the back wall 28. Such sealing means may be a conventional gasket 56 operatively attached to the peripheral edge of the cover 50. Alternatively, the gasket 56 may be operatively attached to the above referenced terminal edges. An optional gasket 58 may be also provided for sealing the peripheral edge of the second opening 42 formed when the cover 50 is disposed in the second position of FIG. 2.

The apparatus 10 of the present invention further includes means for delivering liquid, such as water, under pressure into the washing chamber 22 and onto the animal 2. Such liquid delivering means includes a predetermined plurality of liquid spraying jet nozzles 60 operatively mounted on the housing 20. Furthermore, a portion of the predetermined plurality of aerated liquid spraying jet nozzles 60 is mounted in each of the front wall 26, back wall 28, bottom wall 24, side walls 30 and may be also mounted in the cover 50. The protrusion of each liquid spraying jet nozzle 60 into the chamber 22 is limited to a relatively low height profile flange saucer-shaped 62. The main body of the spraying jet nozzle 60 extends outwardly from the exterior surfaces of the housing 20, as best shown in FIG. 5. Any conventional spraying jet nozzle 60 may be employed in the present invention. For example, at least one of such predetermined plurality of liquid spraying jet nozzles 60 may be of the aerated type as disclosed in U.S. Pat. No. 6,973,681 issued to Ayeni et al., whose teachings are incorporated into this document by reference thereto. A suction port 68 is also operatively mounted in a predetermined wall of the chamber 22.

Now in a particular reference to FIG. 6, the liquid delivering means further includes a pump 70 that is energizeable to circulate liquid under pressure. A manifold assembly 80 has an inlet 82 thereof operatively coupled to a pump outlet 72 and a plurality of outlets 84, each of the plurality of outlets 84 being operatively coupled to a respective liquid spraying jet nozzle 60. A return conduit 86 is provided and has one end thereof operatively coupled to the suction port 68 and has an opposed end thereof operatively coupled to a pump inlet 74. The pump 70 may be mounted remotely from the housing 20 or affixed to an exterior surface thereof depending on specific application requirements.

A blower 90 may be also provided for supplying air into the liquid spraying jet nozzle 60 of the aerated type through the air manifold 92. The blower 90 may be mounted remotely from the housing 20 or affixed to an exterior surface thereof depending on specific application requirements.

The apparatus 10 of the present invention additionally includes a control means for operating the pump 70 and the blower 90. Such control means includes at least one liquid level sensor 102 mounted a predetermined distance from the bottom wall 24 in one of the side walls 30, front wall 26 and back wall 28. The liquid level sensor 102 provides a liquid level signal upon sensing presence of the liquid in the washing chamber 22. A control assembly 104, either of a microprocessor-type or a descript logic type, is operatively coupled to each of the liquid level sensor 102, pump 70 and blower 90 and operative at least in response to the liquid level signal to energize the pump 70 and blower 90. The control means may further include an ON/OFF switch 106 which is manually operable by the user to activate the control assembly 104 so that it can respond to the liquid level signal from the liquid level sensor 102. The present invention may include an optional sensor 108 mounted in one of the side walls 30, front wall 26, bottom wall 24, back wall 28 and cover 50 for measuring distance from such wall to such animal 2 by transmitting ultrasound signals beamed onto such animal 2 and receiving signals reflected therefrom. The sensor 108 may be of any conventional type. By way of examples only, the sensor 108 may be of type disclosed in U.S. Pat. No. 4,437,032 issued to Gelhard or U.S. Pat. No. 6,370,086 issued to Li. Teachings of U.S. Pat. No. 4,437,032 and U.S. Pat. No. 6,370,086 are incorporated into this document by reference thereto. The present invention also contemplates that more than one sensor 108 may be provided, each preselected to measure a predetermined distance to the animal 2. The control assembly 104 is than adapted to adjust the flow of the liquid through the liquid spraying jet nozzles 60 so as to accommodate animals 2 of various sizes while providing adequate washing conditions.

In further reference to FIG. 3, the apparatus 10 also includes means for draining liquid from the washing chamber 22 and, optionally, for draining liquid from cavities 38. Such liquid draining means includes a drain assembly 110 operatively provided in the bottom wall 24 of the chamber 22. The bottom wall 24 may be sloped toward the drain assembly 110 further advantageously contouring the underside of the animal body 4. The drain assembly 110 may be controlled by a manually operable valve 112 that may be further connected to a drain conduit 116 if the apparatus 10 is used in conditions preventing direct discharge or drainage of the liquid from the washing chamber 22.

There is also a quartet of auxiliary drains 120, best shown in FIGS. 2-4, each provided in a respective hollow abutment 32 and includes an opening 122 formed through a wall of a respective generally hollow abutment 32 and a plug 124 for selectively closing and opening a respective opening 122. Alternatively, the drain assembly 110 may be covered with a simple plug similar in construction to plug 124.

It is also presently preferred for the apparatus 10 to include means, generally designated as 130, for supplying forced heated air into the washing chamber 22 so as to dry the animal 2 after washing process has been completed. By way of an example of FIG. 8, such means 130 includes a casing 132 having each of a predetermined shape, at least one intake port 134 and a discharge port 136. The casing may be mounted remotely from the housing 20 or affixed to an exterior surface thereof. A heating means, such as an electrically operated coil 138 is mounted in proximity to the discharge port 136. A blower motor 140 is disposed within the casing 122 for drawing air through the at least one intake port 134 and exhausting the air through at least a portion of the coil 138 and through the discharge port 136, whereby the exhausted air is heated by the coil 138. At least one air nozzle 142 is operatively mounted within the housing 20. There is also an air conduit 144 having one end thereof operatively connected to the discharge port 138 and having an opposed end thereof operatively connected to the at least one air nozzle 142. Each air nozzle 142 is preferably equipped with a check valve 146 so as to prevent entry of the liquid into the air conduit 144. A switch 107 for controlling operation of such forced heated air supplying means may be also provided. The means 70 may be mounted remotely from the housing 20 or affixed to an exterior surface thereof depending on specific application requirements.

In operation, the user of the apparatus 10 fills the washing chamber 22 with liquid through the first opening 40 at least until the liquid level sensor 102 is covered. Next the body 4 of the animal 2 is inserted into the washing chamber 22 and the cover 50 is moved into the second position closing the first opening 40. At least one latch or locking tab 55 may be provided for temporarily securing the cover in such second position and compressing the gasket 56. The user than uses the switch 106 to activate the control assembly 104 thus delivering liquid through the liquid spraying jet nozzles 60 into the washing chamber 22 and onto the body 4, legs 6 and a portion of the neck 8. Placement of the liquid spraying jet nozzles 60 essentially on all sides of the washing chamber 22 assures that the essentially an entire surface of the animal 2 will be thoroughly cleaned aided by the agitation of the liquid within the washing chamber 22 by way of liquid spraying jet nozzles 60. Furthermore, use of distance measuring sensor 108 outputting a distance signals to the control assembly 104 causes such control assembly 104 to adjust the velocity and/or pressure of the liquid sprayed from the liquid spraying jet nozzles 60 relative to a size of the body 4 disposed within the washing chamber 22, thus controlling the resulting force applied onto such body 4.

When the washing cycle is completed, user drains the water from the washing chamber 22 and optionally from cavities 38 through the drain assemblies 110, 120. The user can then repeat the washing cycle by adding clean water. When washing process is completed, the user activates the means for supplying forced heated air into the washing chamber 22 so as to at least partially dry the animal 2 prior to removing such animal 2 from the washing chamber 22. Advantageously, the means for supplying forced heated air into the washing chamber 22 may be also used for drying the washing chamber 22 after use so as to prevent mold and mildew growth. Such means may be also used to disinfect the washing chamber 22 by way of heat and, accordingly, the control assembly 104 is adapted with means, such as a variable resistance switch 109 to adjust the temperature of the heated air supplied into the washing chamber 22. It would be appreciated that the temperature of the heated air supplied for disinfecting purposes will be greater than the temperature of air that can be safely tolerated by the animal 2.

Although the present invention has been shown in terms of the user manually filling the washing chamber 22 with liquid, it will be apparent to those skilled in the art, that the apparatus 10 of the present invention may be adapted with a member 150 which can be operatively coupled to a conventional hose 152 by way of an intermediary valve 154, as best shown in FIG. 3. The valve 154 is manually operated but may be also operated by way of the control assembly 104. Thus, the user will not be burdened by the effort of manually filling the washing chamber 22 with liquid. A shampoo or soap dispenser 156 may be also provided to assist the user in washing the animal 2. It is also within the scope of the present invention to provide a cone 158 sized to fit into the second opening 42 as to further shield the head 9 of the animal 2 from any liquid.

Additionally, the present invention contemplates that a portion of the manifold assembly 80 connecting the pump 70 to the liquid spraying jet nozzles 60 mounted within the cover 50 may be controlled independently from other portions of the manifold 80, for example, by way of a shut-off valve 160, so as to enable the user to create a shower-like effect within the washing chamber 22. Such shut-off valve 160 would be then position within the manifold assembly 80 so as to allow supply of liquid only to liquid spraying jet nozzles 60 mounted within the cover 50 and terminate supply of liquid to any other liquid spraying jet nozzles 60. It is within the scope of the present invention to provide shut-off valve 160 either of a manually operable type or an electrically operable type coupled to the control assembly 104 and operable by a switch 162 which may be advantageous in commercial applications of the apparatus 10. In this embodiment, the user may elect to keep the drains 110 and 120 in an open condition so as to enable continues drainage of the liquid supplied into he washing chamber 22, for example during a rinsing cycle.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

We claim:

1. A four-legged animal washing apparatus comprising:
(a) a housing defining a washing chamber having each of a predetermined size and a predetermined shape to receive a body of an animal and further defining each of a bottom wall, a front wall, a back wall and a pair of side walls;
(b) a quartet of generally hollow abutments disposed in a predetermined pattern on and extending outwardly from said bottom wall, each of said plurality of generally hollow abutments having a generally closed bottom end and an open top end disposed in open communication with said washing chamber, said each generally hollow abutments defining a cavity having each of a predetermined size and a predetermined shape to receive a respective foot of such animal having such body thereof received within said washing chamber;
(c) a first opening formed in a top portion of said housing;
(d) a second opening formed in operative communication with said first opening in a front portion of said housing, said second opening having a predetermined size to receive a neck of such animal;
(e) a cover pivotally attached to one of said back wall and one of said pair of side walls and manually movable between a closed position and an open position, wherein said cover disposed in said closed position covers said first opening and forms a top wall of said chamber, and wherein a front end of said cover disposed in said closed position is shaped to fit about such neck of such animal;
(f) means for delivering a washing liquid into said washing chamber and onto such animal;
(g) means for controlling operation of said liquid delivering means; and
(h) means operatively mounted within said apparatus for draining said washing liquid from said washing chamber.

2. The apparatus, according to claim 1, wherein said means for delivering said washing liquid includes:
(a) a predetermined plurality of liquid spraying jet nozzles, a portion of said predetermined plurality of liquid spraying jet nozzles mounted in each of said front wall, back wall, bottom wall, side walls and cover;
(b) a pump energizeable to circulate liquid under pressure;
(c) a manifold assembly having an inlet thereof operatively coupled to a pump outlet and a plurality of outlets, each of said plurality of outlets operatively coupled to a respective liquid spraying jet nozzle;
(d) a suction port operatively mounted in a predetermined wall of said washing chamber; and
(e) a conduit having one end thereof operatively coupled to said suction port and having an opposed end thereof operatively coupled to a pump inlet.

3. The apparatus, according to claim 2, wherein said liquid delivering means includes a blower and a manifold for injecting air into at least one of said predetermined plurality of liquid spraying jet nozzles.

4. The apparatus, according to claim 2, wherein said liquid delivering means further includes a valve operatively mounted within said manifold assembly.

5. The apparatus, according to claim 1, wherein said means for controlling operation of said liquid delivering means includes:
(a) a liquid level sensor mounted a predetermined distance from said bottom wall in one of said side walls, front wall and back wall, said liquid level sensor providing a liquid level signal upon sensing presence of said liquid in said washing chamber; and
(b) a control assembly operatively coupled to each of said sensor and said pump and operable at least in response to said liquid level signal to energize said pump.

6. The apparatus, according to claim 1, wherein said apparatus includes means for sealing abutting engagement of said cover with respective terminal edges of said housing.

7. The apparatus, according to claim 6, wherein said sealing means is a gasket.

8. The apparatus, according to claim 1, wherein said liquid draining means includes a drain assembly operatively mounted in said bottom wall of said washing chamber.

9. The apparatus, according to claim 8, wherein said drain assembly includes a valve.

10. The apparatus, according to claim 8, wherein said drain assembly includes a connection to a hose.

11. The apparatus, according to claim 8, wherein said liquid draining means further includes:
(a) a quartet of openings, each of said quartet of opening formed through a wall of a respective generally hollow abutment; and
(b) a quartet of plugs, each of said quartet of plugs selectively closing and opening a respective opening;

12. The apparatus, according to claim 1, wherein said apparatus includes means for supplying forced heated air into said washing chamber.

13. The apparatus, according to claim 1, wherein said apparatus includes means for measuring a distance from an interior surface of said washing chamber to exterior surface of such animal.

14. The apparatus, according to claim 13, wherein said distance measuring means includes least one sensor mounted in one of said side walls, front wall, bottom wall, back wall and cover for measuring said distance by transmitting ultrasound signals beamed onto such animal and receiving signals reflected therefrom.

15. The apparatus, according to claim 1, wherein said apparatus includes a soap dispenser.

16. The apparatus, according to claim 1, wherein said apparatus includes a shield cone operatively and removably engageable with said second opening.

17. A four-legged animal washing apparatus comprising:
(a) a housing defining a washing chamber having each of a predetermined size and a predetermined shape to receive a body of an animal and further defining each of a bottom wall, a front wall, a back wall and a pair of side walls;
(b) a quartet of generally hollow abutments disposed in a predetermined pattern on and extending outwardly from said bottom wall, each of said plurality of generally hollow abutments having a generally closed bottom end and an open top end disposed in open communication with said washing chamber, said each generally hollow abutments defining a cavity having each of a predetermined size and a predetermined shape to receive a respective foot of such animal having such body thereof received within said washing chamber;
(c) a first opening formed by a combination of terminal edge of each side wall and a terminal edge of said back wall;
(d) a second opening formed in said front wall and said pair of side walls in operative communication with said first opening, said second opening having a predetermined size to receive a neck of such animal;
(e) a cover pivotally attached to one of said back wall and one of said pair of side walls and manually movable between a closed position and an open position, wherein said cover disposed in said closed position covers said first opening and forms a top wall of said chamber, and wherein a front end of said cover disposed in said closed position is shaped to fit about such neck of such animal;
(f) means for sealing abutting engagement of said cover with respective terminal edges of said housing;
(g) a predetermined plurality of liquid spraying jet nozzles, a portion of said predetermined plurality of liquid spraying jet nozzles mounted in each of said front wall, back wall, bottom wall, side walls and cover;
(h) a pump energizeable to circulate liquid under pressure;
(i) a manifold assembly having an inlet thereof operatively coupled to a pump outlet and a plurality of outlets, each of said plurality of outlets operatively coupled to a respective liquid spraying jet nozzle;
(j) a suction port operatively mounted in a predetermined wall of said washing chamber;
(k) a conduit having one end thereof operatively coupled to said suction port and having an opposed end thereof operatively coupled to a pump inlet;
(l) a liquid level sensor mounted a predetermined distance from said bottom wall in one of said side walls, front wall and back wall, said liquid level sensor providing a liquid level signal upon sensing presence of said liquid in said washing chamber;
(m) a control assembly operatively coupled to each of said sensor and said pump and operable at least in response to said liquid level signal to energize said pump;
(n) a drain assembly operatively mounted in said bottom wall of said washing chamber;
(o) a quartet of openings, each of said quartet of opening formed through a wall of a respective generally hollow abutment;
(p) a quartet of plugs, each of said quartet of plugs selectively closing and opening a respective opening;
(q) means for supplying forced heated air into said washing chamber; and
(r) at least one sensor mounted in one of said side walls, front wall, bottom wall, back wall and cover for measuring distance from an interior surface of said washing chamber to such animal by transmitting ultrasound signals beamed onto such animal and receiving signals reflected therefrom.

18. The apparatus, according to claim 17, wherein said means for supplying said forced heated air includes:
(a) a casing having each of a predetermined shape, at least one intake port and a discharge port;
(b) a heating means mounted in proximity to said discharge port;
(c) a blower motor disposed within said casing for drawing air through said at least one intake port and exhausting said air through at least a portion of said heating means and through said discharge port, whereby said exhausted air is heated by said heating means;
(d) at least one air nozzle operatively mounted in said housing in air communication with said washing chamber; and
(e) an air conduit having one end thereof operatively connected to said discharge port and having an opposed end thereof operatively connected to said at least air nozzle.

19. The apparatus, according to claim 17, wherein said means for supplying said forced heated air further includes at least one check valve operatively mounted in said air conduit.
